(19) United States
(12) Patent Application Publication
(10) Pub. No.: US 2026/0001311 A1
(43) Pub. Date: Jan. 1, 2026

(54) SEPARATION METHOD AND SEPARATION DEVICE

(71) Applicant: KABUSHIKI KAISHA TOYOTA CHUO KENKYUSHO, Nagakute-shi, Aichi-ken (JP)

(72) Inventors: Yuka YAMADA, Nagakute-shi (JP); Yasuhito KONDO, Nagakute-shi (JP); Hiroki KONDO, Nagakute-shi (JP)

(73) Assignee: KABUSHIKI KAISHA TOYOTA CHUO KENKYUSHO, Nagakute-shi, Aichi-ken (JP)

(21) Appl. No.: 18/880,791

(22) PCT Filed: Jun. 19, 2023
(86) PCT No.: PCT/JP2023/022569

§ 371 Date: Jan. 2, 2025

(30) Foreign Application Priority Data
Jul. 29, 2022 (JP) 2022-121627

(51) Int. Cl. B32B 43/00; H01M 10/54

(52) U.S. Cl. CPC B32B 43/006; H01M 10/54; B32B 2305/70; B32B 2307/202; B32B 2309/04; B32B 2309/66; B32B 2310/028; B32B 2310/0409; B32B 2457/10

(57) ABSTRACT

A separation method includes a separation step in which a treatment target electrode including a current collector and an electrode mixture is treated with an ultrasonic wave in water (a treatment liquid) while the frequency of the ultrasonic wave is swept in order to separate the current collector and the electrode mixture from each other. A separation device includes a separation unit that treats the treatment target electrode with an ultrasonic wave in water to separate the current collector and the electrode mixture from each other and a controller that controls the separation unit such that the ultrasonic treatment is performed while the frequency of the ultrasonic wave is swept.

### TECHNICAL FIELD

The present disclosure relates to a separation method and a separation device.

### BACKGROUND ART

Examples of the methods for separating a current collector and an electrode mixture from each other for battery recycling which have been proposed in the related art include a method in which a small piece of a battery is immersed in a polar solvent, such as water, an alcohol, or a ketone, and mechanical mixing, such as stirring, an ultrasonic treatment, is subsequently performed for about 30 minutes to about 5 hours (PTL 1), a method in which an electrode sheet is treated with an ultrasonic wave such that the power density in the front surface of an ultrasonic electrode is 50 W/cm² or more (PTL 2), a method in which a positive electrode is immersed in NMP for 6 hours at 50° C. and an ultrasonic treatment and scrapping are then performed (NPL 1), a method in which NMP is used as a cleaning liquid for positive electrodes and an ultrasonic treatment is performed for 90 minutes at 70° C. and 240 W (NPL 2), and a method in which an electrode is crushed to 2 to 12 mm and an ultrasonic treatment is subsequently performed at 40 Hz and 100 W (NPL 3).

### CITATION LIST

### Patent Literature

PTL 1: Japanese Patent No. 6828214

PTL 2: International Publication No. 2021/152302

### Non Patent Literature

NPL 1: H. Gao et al., ACS Appl. Mater. Interfaces 12, 2020, 51546-51554.

NPL 2: L.-P. He et al., Waste Management 46, 2015, 523-528.

NPL 3: J. Li et al., Chemosphere 77, 2009, 1132-1136.

### SUMMARY OF INVENTION

### Technical Problem

Although the above-described methods are capable of removing an electrode mixture from a current collector, they may involve damage to the current collector. In another case, even when the damage to the current collector is reduced, the electrode mixture may remain on the current collector. Consequently, a current collector component may enter the separated electrode mixture, or an electrode mixture component may enter the separated current collector. The above-described methods also need a large amount of time for the treatment and require a pretreatment, such as crushing. That is, these methods may have low treatment efficiencies.

The present disclosure was made in order to address the above issues. A primary object of the present disclosure is to separate a current collector and an electrode mixture from each other with high efficiency and high accuracy.

### Solution to Problem

In order to achieve the above object, the inventors of the present invention found that treating an electrode with an ultrasonic wave in water while sweeping the frequency of the ultrasonic wave enables a current collector and an electrode mixture to be separated from each other with high efficiency and high accuracy. Thus, the present disclosure was made.

A separation method of the present invention includes a separation step in which a treatment target electrode that includes a current collector and an electrode mixture disposed on the current collector is treated with an ultrasonic wave in water while a frequency of the ultrasonic wave is swept, in order to separate the current collector and the electrode mixture from each other.

A separation device of the present invention includes:
a separation unit that treats a treatment target electrode including a current collector and an electrode mixture disposed on the current collector with an ultrasonic wave in water to separate the current collector and the electrode mixture from each other; and
a controller that controls the separation unit such that the ultrasonic treatment is performed while a frequency of the ultrasonic wave is swept.

### Advantageous Effects of Invention

The separation method and separation device according to the present disclosure enable a current collector and an electrode mixture to be separated from each other with high efficiency and high accuracy. The reasons for which the above advantageous effects are produced are considered, for example, as follows. The above separation method and separation device use the physical action using the cavitation effects of ultrasonic waves instead of the chemical action of an organic solvent or an aqueous solution. This enables a current collector and an electrode mixture to be separated from each other using water, without using an organic solvent or the like. In addition, since water has a high surface tension and is more likely to produce the cavitation effects than an organic solvent, such as NMP, a current collector and an electrode mixture can be separated from each other with high efficiency. Furthermore, since the ultrasonic treatment is performed in water while the frequency of the ultrasonic wave is swept, a suitable energy distribution can be achieved. This reduces damage to the current collector and the amount of residual electrode mixture and enables a current collector and an electrode mixture to be separated from each other with high accuracy.

### BRIEF DESCRIPTION OF DRAWINGS

FIG. 1 is a diagram illustrating sweeping and a sweep cycle.

FIG. 2 is a diagram illustrating a sweep width.

FIG. 3 is a diagram schematically illustrating the structure of a separation device 10.

FIG. 4 is a diagram illustrating an ultrasonic device 20 that has not performed an ultrasonic treatment.

FIG. 5 is a diagram illustrating an ultrasonic device 20 that has performed an ultrasonic treatment.

FIG. 6 includes photographs illustrating the appearances of electrodes (current collector foils) that had been treated with an ultrasonic wave.

FIG. 7 is a photograph illustrating the appearance of an electrode (a current collector foil) that had been treated with an ultrasonic wave.

FIG. 8 is a flowchart illustrating an example of a separation method.

FIG. 9 is a photograph illustrating the appearances of electrodes that had been treated with an ultrasonic wave after a lapse of different waiting times.

FIG. 10 is a graph illustrating the relationship between a waiting time and a mixture removal rate. FIG. 11 is a graph illustrating the relationship between the pH of the water used for an ultrasonic treatment and a mixture removal rate.

FIG. 12 is a graph illustrating the relationship between the amount of Li eluted and a mixture removal rate.

FIG. 13 is a graph illustrating the relationship between the amount of Al eluted and a mixture removal rate.

FIG. 14 is a graph illustrating the relationship between a mixture removal rate and the Al content in a mixture powder.

### DESCRIPTION OF EMBODIMENTS

### Separation Method

The separation method according to the present disclosure includes a separation step in which a treatment target electrode is treated with an ultrasonic wave in order to separate a current collector and an electrode mixture from each other.

### Treatment Target Electrode

The treatment target electrode includes a current collector and an electrode mixture disposed on the current collector. The treatment target electrode is an electrode included in an ion secondary battery, such as a lithium ion secondary battery, or an energy storage device, such as an electric double-layer capacitor, a hybrid capacitor, or a pseudo-electric double-layer capacitor. The treatment target electrode may also be an electrode removed from a used energy storage device or a degraded energy storage device. The treatment target electrode may be a positive electrode, a negative electrode, or a bipolar electrode that includes a positive electrode mixture disposed on one of the surfaces of the electrode and a negative electrode mixture disposed on the other surface. An electrode extracted from an energy storage device may be directly used as a treatment target electrode without being shredded. The area of the treatment target electrode may be, for example, 10 cm² or more or 30 cm² or more.

Examples of the material that constitutes the current collector include aluminum, copper, titanium, stainless steel, nickel, iron, baked carbon, a conductive polymer, and conductive glass. In particular, in the case where the treatment target electrode is a positive electrode, the current collector preferably includes aluminum. Examples of the shape of the current collector include foil-like, film-like, sheet-like, network-like, punched or expanded, a rath body, a porous body, a foam, and a fiber compact. The thickness of the current collector is, for example, 1 to 500 μm.

The electrode mixture may include an electrode active material, a binder, and a conductant agent or the like as needed. The electrode mixture may be formed by, for example, mixing an electrode active material, a conductant agent, and a binder with one another, adding an appropriate solvent to the resulting mixture to prepare a paste, applying the paste onto the surface of the current collector, subsequently performing drying, and then performing compressing as needed in order to increase electrode density. The electrode mixture may be formed on either one or both of the surfaces of the current collector.

Examples of the electrode active material included in the electrode mixture include the following active materials included in positive electrodes of lithium ion secondary batteries: transition metal sulfides, such as TiS₂, TiS₃, MoS₃, and FeS₂; lithium-manganese complex oxides represented by a fundamental composition formula Li₍₁₋ₓ₎MnO₂ (e.g., 0<x<1, the same applies hereinafter), Li₍₁₋ₓ₎Mn₂O₄, or the like; lithium-cobalt complex oxides represented by a fundamental composition formula Li₍₁₋ₓ₎CoO₂ or the like; lithium-nickel complex oxides represented by a fundamental composition formula Li₍₁₋ₓ₎NiO₂ or the like; lithium-nickel-cobalt-manganese composite oxides represented by a fundamental composition formula Li₍₁₋ₓ₎NiₐCo_{b}Mn_{c}O₂ (a+b+C=1) or the like; lithium-vanadium complex oxides represented by a fundamental composition formula LiV₂O₃ or the like; transition metal oxides represented by a fundamental composition formula V₂O₅ or the like; and lithium iron phosphate. The term “fundamental composition formula” implies that the chemical composition may include another element, such as Al or Mg. Examples of the electrode active material also include active materials included in positive and/or negative electrodes of capacitors and lithium ion capacitors, such as active carbon materials, coke materials, glassy carbon materials, graphite materials, nongraphitizable carbon materials, pyrolytic carbon materials, carbon fibers, carbon nanotubes, and polyacenes. Examples of the electrode active material also include the following active materials included in negative electrodes of lithium ion secondary batteries: inorganic compounds, such as a lithium alloy and a tin compound; carbonaceous materials capable of occluding and releasing lithium ions; complex oxides including a plurality of elements; and conductive polymers. Examples of the carbonaceous materials include coke materials, glassy carbon materials, graphite materials, nongraphitizable carbon materials, pyrolytic carbon materials, and carbon fibers. Examples of the above complex oxides include a lithium-titanium complex oxide and a lithium-vanadium complex oxide. Examples of the conductant agent included in the electrode mixture include graphite materials, such as natural graphite (vein graphite and flake graphite) and synthetic graphite, acetylene black, carbon black, Ketjenblack, carbon whiskers, needle coke, carbon fibers, and metals (e.g., copper, nickel, aluminum, silver, and gold).

The binder included in the electrode mixture binds active material particles and conductant agent particles to one another. The binder may be an organic binder, which is used in the form of a solution prepared by dissolving the binder in an organic solvent. The binder may also be an aqueous binder, which is used in the form of a solution prepared by dissolving the binder in an aqueous solvent. In another case, the binder may be a mixture thereof. Examples of the organic binder include fluororesins, such as polytetrafluoroethylene (PTFE), polyvinylidene fluoride (PVdF), and fluorine rubbers; thermoplastic resins, such as polypropylene and polyethylene; an ethylene propylene diene monomer (EPDM) rubber; a sulfonated EPDM rubber; and a natural butyl rubber (NBR). Examples of the aqueous binder include polyvinyl alcohol (PVA), a styrene-butadiene copolymer (SBR), and polyethylene oxide (PEO). The above aqueous binder may include carboxymethyl cellulose (CMC). Examples of the organic solvent include N-methylpyrrolidone, dimethylformamide, dimethylacetamide, methyl ethyl ketone, cyclohexanone, methyl acetate, methyl acrylate, diethylenetriamine, N, N-dimethylaminopropylamine, ethylene oxide, and tetrahydrofuran. Examples of the aqueous solvent include water and various aqueous solutions. Examples of the conductant agent included in the electrode mixture include graphite materials, such as natural graphite (vein graphite and flake graphite) and synthetic graphite, acetylene black, carbon black, Ketjenblack, carbon whiskers, needle coke, carbon fibers, and metals (e.g., copper, nickel, aluminum, silver, and gold). The above conductant agents may be used alone or in a mixture of two or more. Among these, carbon black or acetylene black is preferably used as a conductant agent in consideration of electron conductivity and ease of coating.

### Separation Step

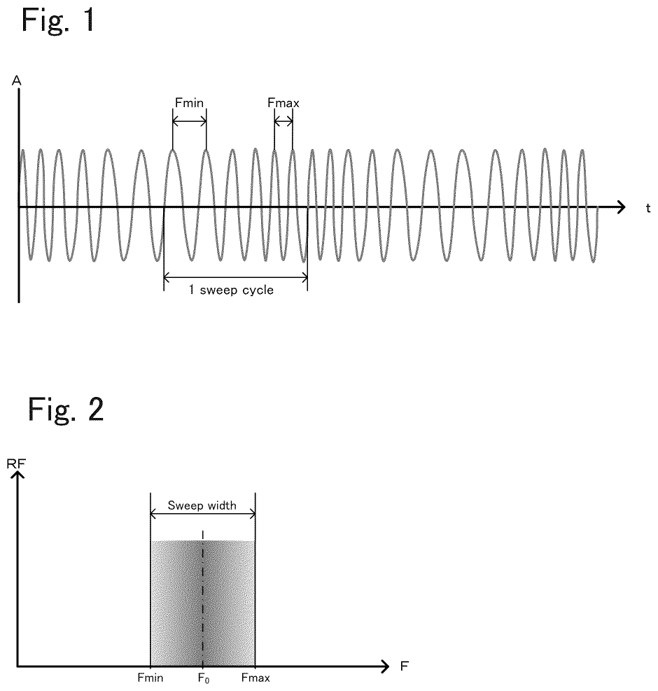

In the separation step, the treatment target electrode is treated with an ultrasonic wave in water (specifically, while the treatment target electrode is immersed in water) while the frequency of the ultrasonic wave is swept, in order to separate the current collector and the electrode mixture from each other. The expression “frequency is swept” used herein means that frequency is changed in a periodic manner, for example, as illustrated in FIGS. 1 and 2.

In the separation step, the frequency of the ultrasonic wave may be changed in a periodic manner such that it varies between the maximum frequency Fmax and the minimum frequency Fmin in a reciprocating manner with the fundamental frequency F₀ being the center (see FIGS. 1 and 2). The fundamental frequency F₀ is preferably 40 kHz or more and 240 kHz or less and is more preferably 80 kHz or more and 200 kHz or less.

In the separation step, when the range in which the frequency varies with the fundamental frequency F₀ being the center is defined as “sweep width” (see FIG. 2), the sweep width may be within ±5 kHz. That is, the following relationships may be satisfied: Fmax−F₀≤+5 KHz and Fmin−F₀≥−5 kHz. The sweep width may be within ±3 kHz and may be within ±1 kHz.

In the separation step, when the interval between the rising edge of a wave that has the minimum frequency Fmin and the falling edge of a wave that has the maximum frequency Fmax (alternatively, half of the interval between the rising edge of a wave that has the minimum frequency Fmin and the rising edge of the subsequent wave that has the minimum frequency Fmin) is defined as one sweep cycle (see FIG. 1) and the number of the sweep cycles per second is defined as “sweep rate”, the sweep rate may be 500 sweep cycles/sec or more. The sweep rate may be 700 sweep cycles/sec or more and may be 1000 sweep cycles/sec or more. The sweep rate may also be 2000 sweep cycles/sec or less.

In the separation step, the amount of time during which the ultrasonic treatment is performed is preferably 30 minutes or less, is more preferably 10 minutes or less, is further preferably 300 seconds or less, and is still further preferably 180 seconds or less. In the separation step, the amount of time during which the ultrasonic treatment is performed may be 1 second or more, 5 seconds or more, or 15 seconds or more.

In the separation step, when the area of the contact portion between the current collector and the electrode mixture is defined as A [cm²] and the output of the ultrasonic wave (the output of the oscillator) is defined as B [W], the ultrasonic treatment is preferably performed such that an output density (power density) represented by B/A is 30 W/cm² or less. The output density B/A is preferably 10 W/cm² or less and may be 5 W/cm² or less. The output density B/A may be 0.1 W/cm² or more and may be 0.5 W/cm² or more.

In the separation step, the ultrasonic treatment is preferably performed in an unheated environment. The temperature at which the ultrasonic treatment is performed in the separation step may be, for example, 0° C. or more and 30° C. or less and may be 15° C. or more and 25° C. or less.

As a result of the above-described separation step, the electrode mixture is removed from the current collector. The electrode mixture removed from the current collector is dissolved and/or dispersed in water or precipitates in water. Thus, subsequent to the ultrasonic treatment, the current collector and the electrode mixture are separated from each other, and the current collector and a mixture-containing water that includes the electrode mixture are obtained.

The proportion of a component (current collector component) that corresponds to the current collector included in the electrode mixture separated in the separation step is preferably less than 0.18%, is preferably less than 0.15%, and is more preferably less than 0.1%. The proportion of a component (electrode mixture component) that corresponds to the electrode mixture included in the current collector separated in the separation step is preferably less than 0.36%, is preferably less than 0.3%, and is more preferably less than 0.2%. The “proportion of the current collector component included in the electrode mixture” may be a value determined by, for example, the following method. Water is removed from the mixture-containing water obtained in the separation step in order to obtain an electrode mixture. The weight of the current collector component included in the electrode mixture is determined by inductively coupled plasma optical emission spectroscopy (ICP). The ratio of the weight of the current collector component to the weight of the electrode mixture that is to be analyzed is calculated. The above weight ratio is used as the proportion of the current collector component included in the electrode mixture. The “proportion of the electrode mixture component included in the current collector” may be a value determined by, for example, the following method. The electrode (current collector) that has been subjected to the ultrasonic treatment is taken and subjected to rinsing and drying. The weight of the electrode mixture component included in the rinsed, dry electrode is determined by ICP. The ratio of the weight of the electrode mixture component to the weight of the electrode that is to be analyzed is calculated. The above weight ratio is used as the proportion of the electrode mixture component included in the current collector. Alternatively, the proportion of the weight of the electrode mixture component included in the rinsed, dry electrode is determined by a fundamental parameter method (FP method) in X-ray fluorescence analysis (XRF), and the above weight proportion is used as the proportion of the electrode mixture component included in the current collector. The proportion of the electrode mixture component included in the current collector may be the proportion of the active material component included in the current collector. In the case where the active material includes a transition metal, the proportion of the electrode mixture component included in the current collector may be the proportion of the transition metal (i.e., the transition metal included in the active material) included in the current collector. Since transition metals may be alloyed with the current collector component disadvantageously when the current collector (e.g., Al) is remelted, it is desirable that the amount of the transition metal that remains on the current collector be small.

In the separation step, the rejection rate at which the electrode mixture is removed from the current collector (hereinafter, the above rejection rate is also referred to as “mixture removal rate”) is preferably increased. The mixture removal rate is preferably, for example, 90% or more, is more preferably 97% or more, and is further preferably 99% or more. In the separation step, the pH of the water used for the ultrasonic treatment is preferably reduced. The pH of the water may be increased as a result of a component of the treatment target electrode being eluted into the water. The smaller the increase in pH, the higher the mixture removal rate. The above pH is preferably, for example, 11.5 or less, is more preferably less than 11.4, and is further preferably less than 11.2. The above pH may be, for example, 6 or more, 7 or more, or 10 or more. In the separation step, the concentration of the alkali metal component in the water used for the ultrasonic treatment is preferably reduced. In the case where the active material or the like included in the treatment target electrode includes an alkali metal component, the alkali metal component may elute into the water used for the ultrasonic treatment. The lower the concentration of the alkali metal component, the higher the mixture removal rate. The concentration of the alkali metal component is preferably 37.5 mg/L or less, is more preferably less than 33 mg/L, and is further preferably less than 32 mg/L. In the separation step, the amount of the current collector dissolved in water per weight of the current collector is preferably reduced. The smaller the amount of the current collector dissolved in water, the higher the mixture removal rate. The amount of the current collector dissolved in water is preferably 1.1% or less, is more preferably less than 1.0%, and is further preferably less than 0.9%. In the separation step, the amount of waiting time during which the treatment target electrode that has not been subjected to the ultrasonic treatment is held in water is preferably reduced. The shorter the above waiting time, the higher the degree of reductions in the elution of a component of the treatment target electrode into the water. This reduces, for example, the reaction of the eluted component with the electrode mixture or the current collector and consequently increases the mixture removal rate. The above waiting time is preferably, for example, 30 minutes or less, is more preferably less than 5 minutes, and is further preferably less than 3 minutes.

In the separation step, the proportion of the weight of the current collector component included in the separated electrode mixture is preferably reduced. The above weight proportion is preferably, for example, 0.18% or less, is more preferably 0.15% or less, and is more preferably less than 0.1%. The higher the above-described mixture removal rate, the smaller the weight proportion. Therefore, in order to also reduce the above weight proportion, in the separation step, the above-described pH is also preferably reduced, the concentration of the alkali metal component in the water used for the ultrasonic treatment is also preferably reduced, the amount of the current collector dissolved in water is also preferably reduced, and the amount of waiting time is also preferably reduced.

An extraction step in which an electrode is extracted from an energy storage device may be optionally conducted prior to the separation step. The electrode extracted in the extraction step may be used as a treatment target electrode without being shredded or after being cut to, for example, an area of 10 cm² or more or 30 cm² or more.

A current collector treatment step in which the current collector separated in the separation step is rinsed and dried may be optionally conducted subsequent to the separation step. The current collector may be rinsed while a rinsing liquid is fed to the current collector or while the current collector is immersed in a rinsing liquid. The rinsing liquid is preferably water. For drying the current collector, fan drying, heat drying, vacuum drying, barrel drying, spin drying, suction drying, or infrared drying may be used. The above drying methods may be used in a combination of two or more.

A mixture treatment step in which the electrode mixture is separated from the mixture-containing water, which is obtained in the separation step, by filtration and then dried may be optionally conducted subsequent to the separation step. In the mixture treatment step, the electrode mixture may be rinsed while or after the electrode mixture has been filtered. The rinsing liquid is preferably water. For drying the electrode mixture, fan drying, heat drying, vacuum drying, barrel drying, spin drying, suction drying, or infrared drying may be used. The above drying methods may be used in a combination of two or more. In the mixture treatment step, instead of filtering the electrode mixture, a solid-liquid separation technique, such as centrifugation or evaporation to dryness, may be used for separating the electrode mixture from the mixture-containing water.

The separation step, the current collector treatment step, and the mixture treatment step may be conducted in a batch or continuous mode. In the case where the separation step and the current collector treatment step are conducted in a continuous mode, a roll-to-toll process may be employed. In the case where the separation step is conducted by a roll-to-toll process, the electrode extracted in the extraction step is successively coiled in a roll, which may be used as a treatment target electrode.

Since the current collector and the electrode mixture are produced by the above separation method, the separation method is considered also as a method for producing a current collector and as a method for producing an electrode mixture.

### Separation Apparatus

The separation device according to the present disclosure includes a separation unit that treats a treatment target electrode with an ultrasonic wave in order to separate a current collector and an electrode mixture from each other and a controller that controls the separation unit. This separation device may be used for performing the above-described separation method. Thus, the structures and conditions described in Separation Method above may apply to the separation device. The separation device may include an import unit that imports a treatment target electrode into the separation unit and an export unit that exports at least one of the current collector and electrode mixture, which are separated in the separation unit from each other, from the separation unit. The controller may control the separation unit, the import unit, and the export unit such that the ultrasonic treatment is performed in a batch or continuous mode.

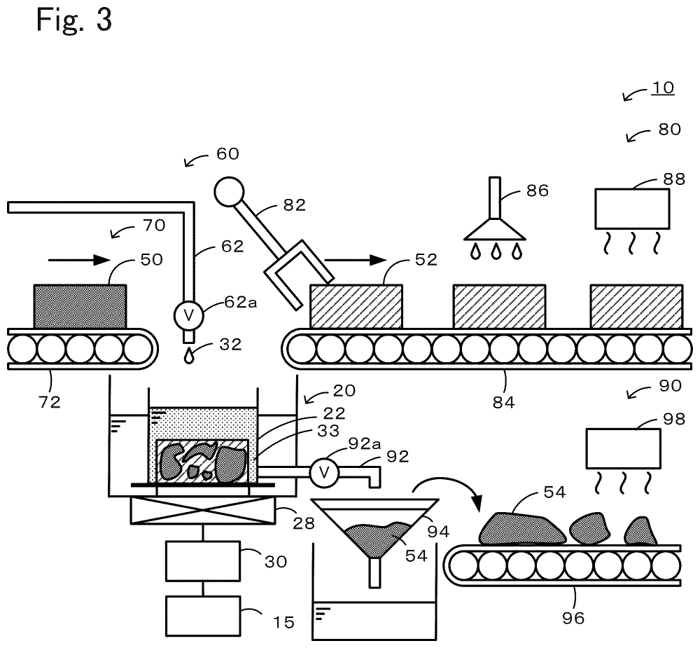

A separation device 10 is described as an example of the separation device below. FIG. 3 is a diagram schematically illustrating the structure of the separation device 10. The separation device 10 includes a separation unit 60, an import unit 70, a current collector export unit 80 and a mixture export unit 90 that serve as export units, and a controller 15. The separation device 10 treats a treatment target electrode 50 that includes a current collector 52 and an electrode mixture 54 with an ultrasonic wave in order to separate the current collector 52 and the electrode mixture 54 from each other. The treatment target electrode 50, the current collector 52, and the electrode mixture 54 may be the same as the treatment target electrode, the current collector, and the electrode mixture described in Separation Method above, respectively.

The separation unit 60 includes an ultrasonic device 20 and a pipe 62 through which water that serves as a treatment liquid 32 is fed to a treatment container 22 included in the ultrasonic device 20. The pipe 62 is provided with a valve 62a, which is arranged to select whether the treatment liquid 32 is fed to the treatment container 22 and adjust the rate at which the treatment liquid 32 is fed.

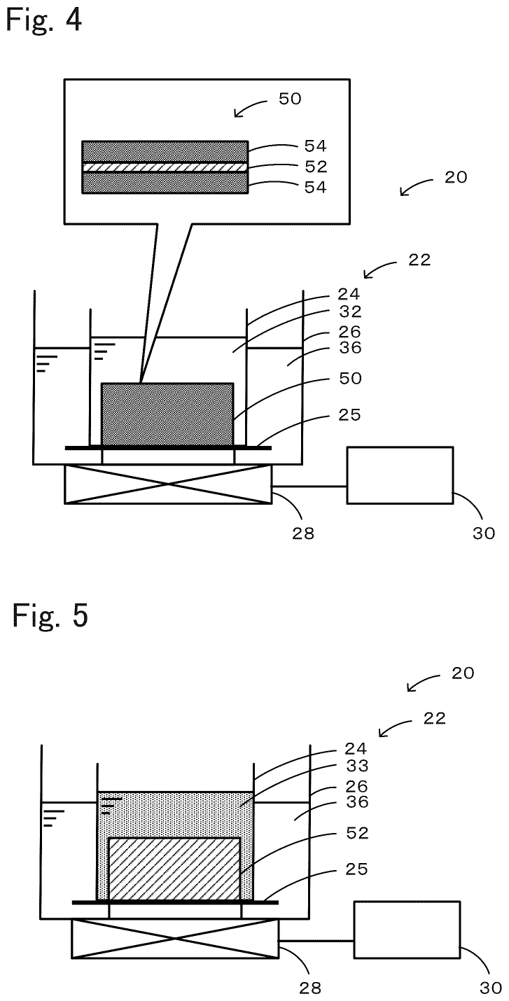

The ultrasonic device 20 treats the treatment target electrode 50 with an ultrasonic wave in water. FIGS. 4 and 5 illustrate the ultrasonic device 20 that has not and has performed the ultrasonic treatment, respectively. The ultrasonic device 20 includes a treatment container 22 that accommodates the treatment target electrode 50 and the treatment liquid 32, a vibrator 28 arranged to come into contact with the treatment container 22, and an oscillator 30 that feeds an electrical signal to the vibrator 28 to cause the oscillation of the vibrator 28. The treatment liquid 32 is water. The water may be tap water, distilled water, ion-exchange water, or the like. The treatment container 22 of the ultrasonic device 20 accommodates water that serves as a treatment liquid 32. The ultrasonic device 20 treats the treatment target electrode 50 with an ultrasonic wave by causing the oscillator 20 to feed electric power to the vibrator 18 and cause the oscillation of the vibrator 18 while the treatment target electrode 50 is immersed in the treatment liquid 32 (see FIG. 4). As a result of the above ultrasonic treatment, the current collector 52 and electrode mixture 54 included in the treatment target electrode 50 are separated from each other and the current collector 52 and a mixture-containing treatment liquid 33 including the electrode mixture 54 (mixture-containing water) can be obtained (see FIG. 5). The treatment container 22 includes an inner tank 24 that accommodates the treatment target electrode 50, a stage 25 on which the inner tank 24 is placed, and an outer tank 26 that accommodates the inner tank 24 and the stage 25. The inner tank 24 accommodates the treatment liquid 32. The outer tank 26 accommodates an ultrasound propagating medium 36. The ultrasound propagating medium 36 is water or the like and responsible for the propagation of ultrasonic waves together with the treatment liquid 32.

The oscillator 30 included in the ultrasonic device 20 has a sweep function. The sweep function is a function of changing frequency in a periodic manner, for example, as illustrated in FIGS. 1 and 2. The ultrasonic device 20 is capable of sweeping (changing in a periodic manner) the frequency of the ultrasonic wave generated from the vibrator 28 using the sweep function of the oscillator 30.

The import unit 70 includes a conveyor 72 with which the treatment target electrode 50 is transported to the separation unit 60. The import unit 70 may include a extracting unit (not illustrated in the drawing) that disassembles a battery to take an electrode that is to be used as a treatment target electrode 50. The extracting unit may include a discharge unit that causes the battery to discharge prior to the disassembling of the battery. In the discharge unit, the battery may be forcibly discharged using an external power source. The extracting unit may also include an inactivation unit that inactivates the battery. In the inactivation unit, the battery may be inactivated by heating. Alternatively, an inactivator may be fed to the inside of the battery. The import unit 70 may include a pretreatment unit (not illustrated in the drawing) that treats the electrode extracted in the extracting unit such that the electrode is suitable for the ultrasonic treatment performed in the separation unit 60. In the pretreatment unit, the electrode extracted in the extracting unit may be cleaned or dried. In the pretreatment unit, the electrode extracted in the extracting unit may be cut to an area of 10 cm² or more or an area of 30 cm² or more. The electrode extracted in the extracting unit may be successively coiled in a roll. The import unit 70 may have any structure that allows the treatment target electrode 50 to be imported to the separation unit 60. For example, the import unit 70 may include a transportation device other than the conveyor 72. The extracting unit and the pretreatment unit may be formed separately from the import unit 70.

The current collector export unit 80 includes a robot arm 82 with which the current collector 52 separated in the separation unit 60 is taken from the treatment container 22 and a conveyor 84 that transports the current collector 52 taken with the robot arm 82. The current collector export unit 80 further includes a rinsing device 86 with which the current collector 52 transported by the conveyor 84 is rinsed and a drying device 88 with which the current collector 52 transported by the conveyor 84 is dried. The rinsing device 86 may perform rinsing while a rinsing liquid is fed to the current collector 52 as illustrated in FIG. 3 or while the current collector 52 is immersed in a rinsing liquid. The rinsing liquid is preferably water. The drying device 88 may perform drying by fan drying, heat drying, vacuum drying, barrel drying, spin drying, suction drying, or infrared drying or using these drying methods in a combination of two or more. The current collector export unit 80 may have any structure that allows the current collector 52 to be exported from the separation unit 60. For example, any one of the robot arm 82 and the conveyor 84 may be omitted. In another case, the current collector export unit 80 may include a transportation device other than the robot arm 82 or the conveyor 84. The rinsing device 86 and the drying device 88 may be formed separately from the current collector export unit 80 and may be omitted.

The mixture export unit 90 includes a pipe 92 through which the mixture-containing treatment liquid 33 obtained in the separation unit 60 is discharged from the treatment container 22, a filtering device 94 with which the electrode mixture 54 is separated from the mixture-containing treatment liquid 33 by filtration, a conveyor 96 that transports the electrode mixture 54 separated with the filtering device 94 by filtration, and a drying device 98 with which the electrode mixture 54 separated with the filtering device 94 by filtration is dried. The pipe 92 is connected to the vicinity of the bottom of the treatment container 22. The pipe 92 is provided with a valve 92a, with which whether the treatment liquid 32 and the mixture-containing treatment liquid 33 are accommodated in or discharged from the treatment container 22 can be controlled. The drying device 98 may perform drying by fan drying, heat drying, vacuum drying, barrel drying, spin drying, suction drying, or infrared drying or using these drying methods in a combination of two or more. The mixture export unit 90 may include a rinsing device with which the electrode mixture 54 is rinsed. The rinsing device may feed a rinsing liquid to the filtering device 94 such that rinsing is performed while the above filtration is performed and may rinse the electrode mixture 54 separated by filtration with a rinsing liquid. The rinsing liquid is preferably water. The mixture export unit 90 may have any structure that allows the electrode mixture 54 to be exported from the separation unit 60. Any one of the pipe 92 and the conveyor 96 may be omitted. In another case, the mixture export unit 90 may include a transportation device other than the pipe 92 or the conveyor 96. The filtering device 94, the drying device 98, the rinsing device, and the like may be formed separately from the mixture export unit 90 and may be omitted. The mixture export unit 90 may include a solid-liquid separation device, such as a centrifuge or an evaporation-to-dryness device, instead of the filtering device 94.

The controller 15 is a microprocessor composed primarily of a CPU and includes, in addition to the CPU, a memory, an input/output port, and the like (not illustrated in the drawing). The controller 15 is connected to the separation unit 60 (specifically, the oscillator 30 and the valve 62a of the pipe 62), the import unit 70 (specifically, the conveyor 72), the current collector export unit 80 (specifically, the robot arm 82, the conveyor 84, the rinsing device 86, and the drying device 88), and the mixture export unit 90 (specifically, the valve 92a of the pipe 92, the filtering device 94, the conveyor 96, and the drying device 98). The controller 15 controls the separation unit 60, the import unit 70, the current collector export unit 80, and the mixture export unit 90 such that an ultrasonic treatment is performed in a batch mode while the frequency of the ultrasonic wave is swept. The conditions under which the ultrasonic treatment is performed may be the same as the conditions described in “Separation Method” (specifically, “Separation Step”) above. Note that FIG. 3 illustrates only the connection between the controller 15 and the oscillator 30; illustration of the other connections is omitted for the sake of illustration.

An example of the operation of the separation device 10 is described below. Upon the controller 15 receiving a command to start the separation treatment, the controller 15 causes the conveyor 72 to transport a treatment target electrode 50 placed on the conveyor 72 into the treatment container 22 included in the separation unit 60. Simultaneously, the controller 15 causes the valve 62a of the pipe 62 to feed a predetermined amount of water, which serves as a treatment liquid 32, to the treatment container 22. After the import of the treatment target electrode 50 and the feeding of the treatment liquid 32 have been completed, the controller 15 causes the oscillator 30 to feed an electrical signal to the vibrator 28 to cause the oscillation of the vibrator 28. Consequently, the treatment target electrode 50 included in the treatment liquid 32 is treated with an ultrasonic wave. In the ultrasonic treatment, the controller 15 causes the oscillator 30 to sweep frequency at, for example, a fundamental frequency F₀ of 40 kHz or more and 240 kHz or less, a sweep width of within ±5 kHz, and a sweep rate of 500 sweep cycles/sec or more, using the sweep function of the oscillator 30. The controller 15 also causes the oscillator 30 to output electric power such that, for example, the output density B/A is 30 W/cm² or less. The controller 15 also causes the oscillator 30 to perform the ultrasonic treatment for a predetermined amount of time, that is, for example, 1 second or more and 30 minutes or less. As a result of the above-described ultrasonic treatment, the current collector 52 and the electrode mixture 54 included in the treatment target electrode 50 are separated from each other, and the current collector 52 and a mixture-containing treatment liquid 33 including the electrode mixture 54 can be obtained. Subsequently, the controller 15 causes the robot arm 82 to take the current collector 52 from the treatment container 22 and place the current collector 52 on the conveyor 84. The controller 15 subsequently causes the conveyor 84 to transport the current collector 52. During the transportation of the current collector 52, the controller 15 causes the rinsing device 86 to rinse the current collector 52 and subsequently causes the drying device 88 to dry the current collector 52. Simultaneously with the export of the current collector 52, the controller 15 controls the valve 92a of the pipe 92 such that the mixture-containing treatment liquid 33 is discharged from the treatment container 22 and fed to the filtering device 94, in which the electrode mixture 54 is separated from the mixture-containing treatment liquid 33 by filtration. After the separation of the electrode mixture 54 by filtration has been completed, the controller 15 causes the filtering device 94 to discharge the electrode mixture 54 onto the conveyor 96 and also causes the conveyor 96 to transport the electrode mixture 54. During the transportation of the electrode mixture 54, the controller 15 causes the drying device 98 to dry the electrode mixture 54. Hereby, the separation of the current collector 52 and the electrode mixture 54 included in the treatment target electrode 50 is completed. The separation device 10 performs the ultrasonic treatment in a batch mode by repeating the series of operations described above.

The separation device 10 may optionally include a pH detection unit with which the pH of water accommodated in the treatment container 22 is measured and may conduct the separation step such that the pH of the water does not exceed a predetermined value (e.g., 11.5). The separation device 10 may optionally include an alkali metal-component detection unit that detects an alkali metal component included in water accommodated in the treatment container 22 and may conduct the separation step such that the concentration of the alkali metal component in the water does not exceed a predetermined value (e.g., 37.5 mg/L). The separation device 10 may optionally include a current collector-component detection unit that detects a current collector component included in water accommodated in the treatment container 22 and may conduct the separation step such that the amount of the current collector component included in the water per weight of the current collector does not exceed a predetermined value (e.g., 1.1%). The separation device 10 may optionally include a waiting time measuring unit that measures the above-described waiting time and may start the ultrasonic treatment within the predetermined waiting time (e.g., within 30 minutes).

The above-described separation method and the above-described separation device enable the current collector and the electrode mixture to be separated from each other with high efficiency and high accuracy. The reasons for which the above advantageous effects are produced are considered, for example, as follows. Since the separation method and the separation device use the physical action using the cavitation effects of ultrasonic waves for the separation of the current collector and the electrode mixture, the current collector and the electrode mixture can be separated from each other using water. Since water has a high surface tension and is more likely to produce the cavitation effects than an organic solvent, the current collector and the electrode mixture can be separated from each other with high efficiency. Furthermore, since the ultrasonic treatment is performed in water while the frequency of the ultrasonic wave is swept, a suitable energy distribution can be achieved. This reduces damage to the current collector and the amount of residual electrode mixture and consequently enables the current collector and the electrode mixture to be separated from each other with high accuracy. It is also advantageous that, since the separation method and the separation device use the physical action using the cavitation effects of ultrasonic waves, the current collector and the electrode mixture can be separated from each other using water regardless of whether the binder included in the electrode mixture is aqueous or organic. Furthermore, since water is used as a treatment liquid, the costs for the treatment liquid are relatively low, the treatment liquid can be readily removed from the separated current collector or electrode mixture, and the waste fluid can be readily treated, which reduces environmental loads. Moreover, since the current collector and the electrode mixture can be separated from each other with high efficiency, the current collector and the electrode mixture can be separated from each other with high accuracy even at, for example, high frequencies (low energy) of 40 to 240 kHz (preferably, 80 to 200 kHz), even when the treatment target electrode is relatively large, or even in an unheated environment.

It should be noted that the present disclosure is not limited by the embodiments described above and can naturally be implemented in various modifications without departing from the technical scope of the present disclosure.

For example, although the separation device 10 includes a separation unit 60, an import unit 70, a current collector export unit 80, and a mixture export unit 90 in the above-described embodiment, one or more components selected from the import unit 70, the current collector export unit 80, and the mixture export unit 90 may be omitted. Although the above-described separation unit 60 includes an ultrasonic device 20 and a pipe 62, the pipe 62 may be omitted in the case where the separation unit 60 has any structure that allows an ultrasonic treatment of the treatment target electrode 50 to be performed in water.

Although the separation device 10 performs the ultrasonic treatment in a batch mode in the above-described embodiment, the ultrasonic treatment may be performed in a continuous mode. In such a case, the import unit 70 may include, instead of the conveyor 72, as a transportation device, a feed device with which the treatment target electrode 50 coiled in a roll is fed. The current collector export unit 80 may also include, instead of the robot arm 82 and the conveyor 84, as a transportation device, a coiling device with which the current collector 52 is coiled.

The present disclosure may be any one of [1] to [14].
[1]

A separation method comprising a separation step in which a treatment target electrode that includes a current collector and an electrode mixture disposed on the current collector is treated with an ultrasonic wave in water while a frequency of the ultrasonic wave is swept, in order to separate the current collector and the electrode mixture from each other.
[2]

The separation method according to [1], wherein, in the separation step, the treatment target electrode including the electrode mixture including at least one selected from an organic binder and an aqueous binder is treated with the ultrasonic wave.
[3]

The separation method according to [1] or [2], wherein, in the separation step, the sweeping is performed with a center being a fundamental frequency of 80 kHz or more and 200 kHz or less.
[4]

The separation method according to any one of [1] to [3], wherein, in the separation step, the sweeping is performed at a sweep width of within ±3 kHz with a center being a fundamental frequency.
[5]

The separation method according to any one of [1] to [4], wherein, in the separation step, the sweeping is performed at a sweep rate of 500 sweep cycles/sec or more.
[6]

The separation method according to any one of [1] to [5], wherein, in the separation step, the ultrasonic treatment is performed for 10 minutes or less.
[7]

The separation method according to any one of [1] to [6], wherein, in the separation step, when an area of a contact portion between the current collector and the electrode mixture is defined as A [cm²] and an output of the ultrasonic wave is defined as B [W], the ultrasonic treatment is performed such that an output density represented by B/A is 10 W/cm² or less.
[8]

The separation method according to any one of [1] to [7], wherein a proportion of the current collector component included in the electrode mixture separated in the separation step is less than 0.1% and a proportion of the electrode mixture component included in the current collector separated in the separation step is less than 0.2%.
[9]

The separation method according to any one of [1] to [8], wherein, in the separation step, the ultrasonic treatment is performed in an unheated environment.
[10]

The separation method according to any one of [1] to [9], wherein the ultrasonic treatment is performed in a batch or continuous mode.
[11]

The separation method according to any one of [1] to [10], the method further comprising:
an extraction step in which an electrode is extracted from an energy storage device,
wherein, in the separation step, the electrode extracted in the extraction step is used as the treatment target electrode and treated with the ultrasonic wave without being shredded.
[12]

The separation method according to any one of [1] to [11], the method further comprising at least one selected from a current collector treatment step in which the current collector separated in the separation step is rinsed and subsequently dried and a mixture treatment step in which the electrode mixture is separated from mixture-containing water and subsequently dried, the mixture-containing water including the electrode mixture separated in the separation step.
[13]

The separation method according to any one of [1] to [12], wherein the separation step is conducted such that one or more selected from (1) to (6) below are satisfied:
(1) in the separation step, a pH of the water used for the ultrasonic treatment is 11.5 or less,
(2) in the separation step, a concentration of an alkali metal component in the water used for the ultrasonic treatment is 37.5 mg/L or less,
(3) in the separation step, an amount of the current collector dissolved in the water per weight of the current collector is 1.1% or less,
(4) in the separation step, an amount of waiting time during which the treatment target electrode that has not been subjected to the ultrasonic treatment is held in the water is 30 minutes or less,
(5) in the separation step, a proportion of the current collector component in the separated electrode mixture is 0.18% by weight or less, and
(6) in the separation step, a rejection rate at which the electrode mixture is removed from the current collector is 90% or more.

A separation device comprising:
a separation unit that treats a treatment target electrode including a current collector and an electrode mixture disposed on the current collector with an ultrasonic wave in water to separate the current collector and the electrode mixture from each other; and
a controller that controls the separation unit such that the ultrasonic treatment is performed while a frequency of the ultrasonic wave is swept.

### EXAMPLES

Examples in which the separation method according to the present disclosure was implemented are described below. Test Examples 1 to 14 and Test Example 19 correspond to Examples, while Test Examples 15 to 18 correspond to Comparative Examples. Test Examples 20 to 28 correspond to Examples.

### 1. Test Examples 1 to 19

### Preparation of Treatment Target Electrodes

Positive electrodes A to C and negative electrodes A and B were prepared as treatment target electrodes as described below (see Table 1).

The positive electrode A was prepared by forming a positive electrode mixture including 92 wt % LiNi_{1/3}Co_{1/3}Mn_{1/3}O₂ (NCM, produced by TODA KOGYO CORP.), 5 wt % acetylene black (produced by Denka Company Limited), and 3 wt % polyvinylidene fluoride (PVDF, produced by Kureha Corporation) into a paste using N-methylpyrrolidone (NMP) and applying the paste onto both surfaces of an aluminum current collector foil having a thickness of 20 μm.

The positive electrode B was prepared by forming a positive electrode mixture including 92 wt % LiNi_{0.8}Co_{0.15}Al_{0.05}O₂ (NCA, produced by TODA KOGYO CORP.), 5 wt % acetylene black (produced by Denka Company Limited), and 3 wt % polyvinylidene fluoride (PVDF, produced by Kureha Corporation) into a paste using NMP and applying the paste onto both surfaces of an aluminum current collector foil having a thickness of 20 μm.

The positive electrode C was prepared by forming a positive electrode mixture including 92 wt % LiFePO₄ (own-synthesized product), 5 wt % acetylene black (produced by Denka Company Limited), and 3 wt % polyvinylidene fluoride (PVDF, produced by Kureha Corporation) into a paste using NMP and applying the paste onto both surfaces of an aluminum current collector foil having a thickness of 20 μm.

The negative electrode A was prepared by forming a negative electrode mixture including 98 wt % graphite (OMAC1.5s, produced by Osaka Gas Chemicals Co., Ltd.), 1 wt % of carboxymethyl cellulose (CMC, produced by Daicel Corporation), and 1 wt % of a styrene-butadiene copolymer (SBR, produced by JSR) into a paste using water and applying the paste onto both surfaces of a copper current collector foil having a thickness of 10 μm.

The negative electrode B was prepared by forming a negative electrode mixture including 98 wt % graphite (SCMG-XR-s, produced by Showa Denko K. K.), 1 wt % of carboxymethyl cellulose (CMC, produced by Daicel Corporation), and 1 wt % of a styrene-butadiene copolymer (SBR, produced by JSR) into a paste using water and applying the paste onto both surfaces of a copper current collector foil having a thickness of 10 μm.

### Ultrasonic Treatment

In the ultrasonic treatment performed in Test Examples 1 to 19, an ultrasonic device (GCX-M-3FQ12 produced by Branson, output: 500 W, outer tank capacity: 20 L) was used. Specifically, as illustrated in FIG. 4, water was charged into an outer tank 26, 40 ml of a treatment liquid 32 was charged into a glass container (an inner tank 24), a treatment target electrode 50 was immersed in the glass container, and ultrasonic wave was applied using a vibrator 28 disposed below the outer tank 26. When the function of sweeping the frequency of the ultrasonic wave was used, the sweep rate was set to 1000 sweep cycles/sec. Note that the power density is the value calculated by dividing the output (500 W) of the ultrasonic device by the area of the contact portion between the current collector foil and the electrode mixture layer (i.e., Electrode area×2). The power density was adjusted by changing the electrode area.

In Test Example 1, the 40 mm×100 mm positive electrode A was used as a treatment target electrode. The treatment liquid used was water. The frequency of the ultrasonic wave (fundamental frequency F₀) was 170 kHz. The sweep condition (sweep width) was ±1 kHz. The treatment time was 60 seconds. The power density was 6.3 W/cm².

In Test Example 2, the 40 mm×100 mm negative electrode A was used as a treatment target electrode. The treatment liquid used was water. The frequency of the ultrasonic waves was 170 kHz. The sweep condition was ±1 kHz. The treatment time was 30 seconds. The power density was 6.3 W/cm².

Test Example 3 was conducted as in Test Example 1, except that the frequency of the ultrasonic wave was changed to 120 kHz. Test Example 4 was conducted as in Test Example 3, except that the treatment time was changed to 30 seconds. Test Example 5 was conducted as in Test Example 3, except that the electrode size was changed to 40 mm×200 mm and the power density was changed to 3.1 W/cm² accordingly. Test Example 6 was conducted as in Test Example 3, except that the treatment target electrode was changed to the positive electrode B. Test Example 7 was conducted as in Test Example 3, except that the treatment target electrode was changed to the positive electrode C.

Test Example 8 was conducted as in Test Example 2, except that the frequency of the ultrasonic wave was changed to 120 kHz. Test Example 9 was conducted as in Test Example 8, except that the treatment time was changed to 10 seconds. Test Example 10 was conducted as in Test Example 8, except that the electrode size was changed to 40 mm×200 mm and the power density was changed to 3.1 W/cm² accordingly. Test Example 11 was conducted as in Test Example 8, except that the treatment time was changed to 60 seconds, the electrode size was changed to 40 mm×715 mm, and the power density was changed to 0.9 W/cm² accordingly. Test Example 12 was conducted as in Test Example 8, except that the treatment target electrode was changed to the negative electrode B.

Test Example 13 was conducted as in Test Example 1, except that the frequency of the ultrasonic wave was changed to 80 kHz. Test Example 14 was conducted as in Test Example 2, except that the frequency of the ultrasonic wave was changed to 80 kHz.

Test Example 15 was conducted as in Test Example 3, except that the sweep condition was changed to “Without sweeping”. Test Example 16 was conducted as in Test Example 8, except that the sweep condition was changed to “Without sweeping”.

Test Example 17 was conducted as in Test Example 3, except that the treatment liquid was changed to NMP. Test Example 18 was conducted as in Test Example 17, except that the frequency of the ultrasonic wave was changed to 40 kHz and the treatment time was changed to 30 seconds.

Test Example 19 was conducted as in Test Example 1, except that the frequency of the ultrasonic wave was changed to 40 kHz.

### Analysis of Proportion of Current Collector Foil Component Included in Mixture

In each of Test Examples 1 to 19, the proportion of the current collector foil component included in the mixture was determined by inductively coupled plasma optical emission spectroscopy (ICP). Specifically, a solution (mixture-containing treatment liquid) including a mixture powder, which had been prepared by the ultrasonic treatment, was filtered under pressure through a membrane filter (Merck Millipore JGWP, 0.45 μm) while cleaning was performed with pure water. Subsequently, drying was performed at 50° C. for 1 hour. Hereby, a mixture powder was obtained. The weight of the current collector foil component (aluminum or copper) included in the mixture powder was determined by ICP. The ratio of the weight of the current collector foil component to the total weight of the mixture powder was calculated. The above ratio was used as the proportion of the current collector foil component included in the mixture. An evaluation grade of “A (Excellent)” was given when the above proportion was less than 0.1%. An evaluation grade of “B (Good)” was given when the above proportion was 0.1% or more and less than 0.18%. An evaluation grade of “F (Failed)” was given when the above proportion was 0.18% or more.

### Analysis of Proportion of Mixture Component Included in Current Collector Foil

In each of Test Examples 1, 3 to 7, 13, 15, and 17 to 19 (positive electrodes), the proportion of the mixture component included in the current collector foil was determined by inductively coupled plasma optical emission spectroscopy (ICP). Specifically, the electrode that had been subjected to the ultrasonic treatment was taken, rinsed with water, and then air-dried. The weight of the mixture component (transition metal component of the mixture; in the positive electrode A, Ni, Co, and Mn) included in the electrode was determined by ICP. The ratio of the weight of the mixture component to the total weight of the electrode was calculated. The above ratio was used as the proportion of the mixture component included in the current collector foil. In each of Test Examples 2, 8 to 12, 14, and 16 (negative electrodes), the proportion of the mixture component included in the current collector foil was determined by a fundamental parameter method (FP method) in X-ray fluorescence analysis (XRF). Specifically, the electrode that had been subjected to the ultrasonic treatment was taken, rinsed with water, and then air-dried. The C content (weight proportion) in the electrode was determined by a FP method in XRF with an analysis range being ϕ30 mm. In the FP method in XRF, a quantitative value was calculated by performing normalization with all the detected elements being 100%. In the measurement of the C content, only one surface and only the surface layer were inspected. The C content determined in the above-described manner was used as the proportion of the mixture component included in the current collector foil. An evaluation grade of “A (Excellent)” was given when the above proportion was less than 0.2%. An evaluation grade of “B (Good)” was given when the above proportion was 0.2% or more and less than 0.36%. An evaluation grade of “F (Failed)” was given when the above proportion was 0.36% or more.

### Results and Discussions

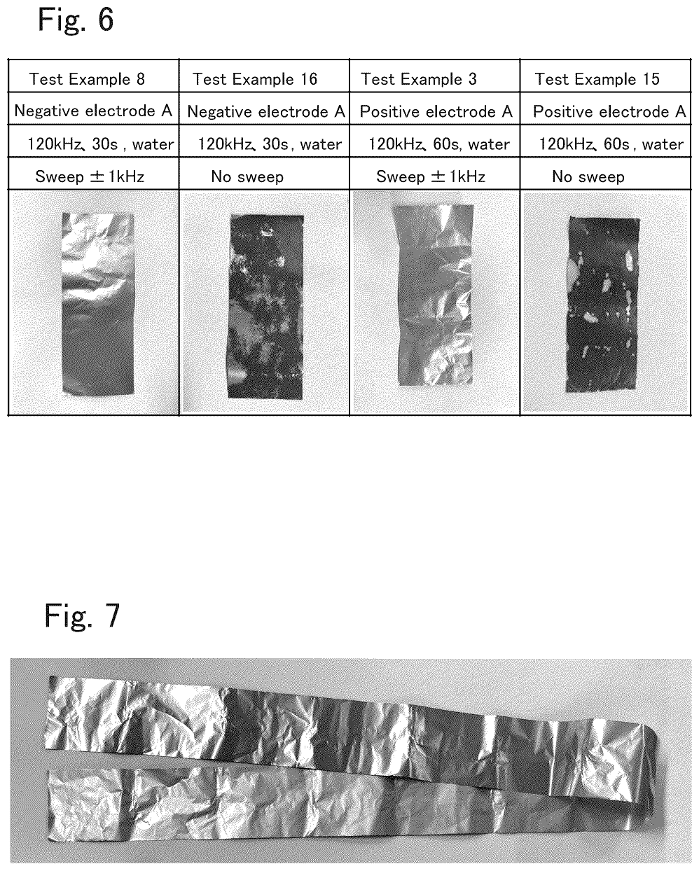

Table 2 summarizes the proportion of the current collector foil component included in the mixture and the proportion of the mixture component included in the current collector foil which were determined in each of Test Examples 1 to 19. FIG. 6 includes photographs illustrating the appearances of the electrodes (current collector foils) that had been subjected to the ultrasonic treatment in Test Examples 8, 16, 3, and 15. FIG. 7 includes a photograph illustrating the appearance of the electrode (current collector foil) that had been subjected to the ultrasonic treatment in Test Example 11.

As described in Table 2, in Test Examples 1 to 14 and Test Example 19, where water was used as a treatment liquid and the ultrasonic treatment was performed using the sweep function, both of the proportion of the current collector foil component included in the mixture and the proportion of the mixture component included in the current collector foil were evaluated as A or B. This confirms that the mixture and the current collector foil could be separated from each other with high accuracy. It is also confirmed that the mixture and the current collector foil could be separated from each other with high accuracy although the amount of time during which the ultrasonic treatment was performed was short, that is, 60 seconds or less. It is further confirmed that the mixture and the current collector foil could be separated from each other with high accuracy although the power density was low, that is, 6.3 W/cm² or less. It is still further confirmed that the mixture and the current collector foil could be separated from each other with high accuracy by performing the ultrasonic treatment with water, regardless of whether an organic binder, which was used as a binder (PVDF) of the positive electrodes, or an aqueous binder, which was used as a binder (SBR) of the negative electrodes, was used.

In contrast, in Test Examples 15 and 16, where water was used as a treatment liquid and the ultrasonic treatment was performed without using the sweep function, a large amount of mixture remained on the current collector foil.

In Test Examples 17 and 18, where NMP was used as a treatment liquid and the ultrasonic treatment was performed using the sweep function, a large amount of mixture also remained on the current collector foil. Since an organic binder is soluble in NMP, it was considered that a larger amount of mixture could be removed in Test Examples 17 and 18, where NMP was used as a treatment liquid, than in Test Examples 3 and 19, where water was used as a treatment liquid. However, in reality, a larger amount of mixture was removed in the case where water was used as a treatment liquid. It is considered that this is because, in the case where NMP is used, the cavitation effects of the ultrasonic wave are weak. Furthermore, between Test Examples 17 and 18, in Test Example 18, where the frequency of the ultrasonic wave was 40 kHz, not only the proportion of the mixture component included in the current collector foil, but also the proportion of the current collector foil component included in the mixture were increased and damage to the current collector foil was increased. Although the frequency of the ultrasonic wave was also 40 kHz in Test Example 19, damage to the current collector foil was reduced compared with Test Example 18. It is considered that this is because water was used as a treatment liquid.

The above-described results confirm that the current collector and the electrode mixture can be separated from each other with high efficiency and high accuracy by performing the ultrasonic treatment using water as a treatment liquid and the sweep function.

TABLE 1

| | | | Electrode mixture | | | | | |
|---|---|---|---|---|---|---|---|---|
| | | | | | Conductant agent | | | |
| | Current collecter | | Active material | | or thickner | | Binder | |
| | | Thickness | | Proportion | | Proportion | | Proportion |
| | Material | (μm) | Material | (wt %) | Material | (wt %) | Material | (wt %) |
| Positive | Aluminum | 20 | LiNi_{1/3}Co_{1/3}Mn_{1/3}O₂ | 92 | Acetylene | 5 | PVDF | 3 |
| electrode A | foil | | | | black | | | |
| Positive | Aluminum | 20 | LiNi_{0.8}Co_{0.15}Al_{0.05}O₂ | 92 | Acetylene | 5 | PVDF | 3 |
| electrode B | foil | | | | black | | | |
| Positive | Aluminum | 20 | LiFePO₄ | 92 | Acetylene | 5 | PVDF | 3 |
| electrode C | foil | | | | black | | | |
| Negative | Copper | 10 | Pitch coat | 98 | CMC | 1 | SBR | 1 |
| electrode A | foil | | graphite | | | | | |
| Negative | Copper | 10 | Meso type | 98 | CMC | 1 | SBR | 1 |
| electrode B | foil | | artificial | | | | | |
| | | | graphite | | | | | |

TABLE 2

| | | | Frequency | | | | Proportion of | | Proportion of | |
|---|---|---|---|---|---|---|---|---|---|---|
| | Treatment | | of | | | | current collector | | mixture component | |
| | target | Treatment | Ultrasonic | Sweep | Treatment | Power | foil component | | included in current | |
| | electrode | liquid | wave | function | time | density | included in mixture | | collector foil | |
| | — | — | kHz | — | s | W/cm² | % | Evaluation¹⁾ | % | Evaluation²⁾ |
| Test | Positive | Water | 170 | ±1 kHz | 60 | 6.3 | 0.03 | A | 0.16 | A |
| Example 1 | electrode A | | | | | | | | | |
| Test | Negative | Water | 170 | ±1 kHz | 30 | 6.3 | 0.01 | A | 0.14 | A |
| Example 2 | electrode A | | | | | | or less | | | |
| Test | Positive | Water | 120 | ±1 kHz | 60 | 6.3 | 0.04 | A | 0.07 | A |
| Example 3 | electrode A | | | | | | | | | |
| Test | Positive | Water | 120 | ±1 kHz | 30 | 6.3 | 0.03 | A | 0.12 | A |
| Example 4 | electrode A | | | | | | | | | |
| Test | Positive | Water | 120 | ±1 kHz | 60 | 3.1 | 0.03 | A | 0.08 | A |
| Example 5 | electrode A | | | | | | | | | |
| Test | Positive | Water | 120 | ±1 kHz | 60 | 6.3 | 0.04 | A | 0.06 | A |
| Example 6 | electrode B | | | | | | | | | |
| Test | Positive | Water | 120 | ±1 kHz | 60 | 6.3 | 0.03 | A | 0.07 | A |
| Example 7 | electrode C | | | | | | | | | |
| Test | Negative | Water | 120 | ±1 kHz | 30 | 6.3 | 0.01 | A | 0.1 | A |
| Example 8 | electrode A | | | | | | or less | | or less | |
| Test | Negative | Water | 120 | ±1 kHz | 10 | 6.3 | 0.01 | A | 0.1 | A |
| Example 9 | electrode A | | | | | | or less | | or less | |
| Test | Negative | Water | 120 | ±1 kHz | 30 | 3.1 | 0.01 | A | 0.1 | A |
| Example 10 | electrode A | | | | | | or less | | or less | |
| Test | Negative | Water | 120 | ±1 kHz | 60 | 0.9 | 0.01 | A | 0.1 | A |
| Example 11 | electrode A | | | | | | or less | | or less | |
| Test | Negative | Water | 120 | ±1 kHz | 30 | 6.3 | 0.01 | A | 0.1 | A |
| Example 12 | electrode B | | | | | | or less | | or less | |
| Test | Positive | Water | 80 | ±1 kHz | 60 | 6.3 | 0.08 | A | 0.04 | A |
| Example 13 | electrode A | | | | | | | | | |
| Test | Negative | Water | 80 | ±1 kHz | 30 | 6.3 | 0.02 | A | 0.1 | A |
| Example 14 | electrode A | | | | | | | | or less | |
| Test | Positive | Water | 120 | None | 60 | 6.3 | 0.01 | A | 36.62 | F |
| Example 15 | electrode A | | | | | | or less | | | |
| Test | Negative | Water | 120 | None | 30 | 6.3 | 0.01 | A | 10.3 | F |
| Example 16 | electrode A | | | | | | or less | | | |
| Test | Positive | NMP | 120 | ±1 kHz | 60 | 6.3 | 0.01 | A | 0.67 | F |
| Example 17 | electrode A | | | | | | or less | | | |
| Test | Positive | NMP | 40 | ±1 kHz | 30 | 6.3 | 0.18 | F | 12.76 | F |
| Example 18 | electrode A | | | | | | | | | |
| Test | Positive | Water | 40 | ±1 kHz | 60 | 6.3 | 0.15 | B | 0.04 | A |
| Example 19 | electrode A | | | | | | | | | |

¹⁾A: less than 0.1%, B: 0.1% or more and less than 0.18%, F: 0.18% or more
²⁾A: less than 0.2%, B: 0.2% or more and less than 0.36%, F: 0.36% or more

### 2. Test Examples 20 to 28

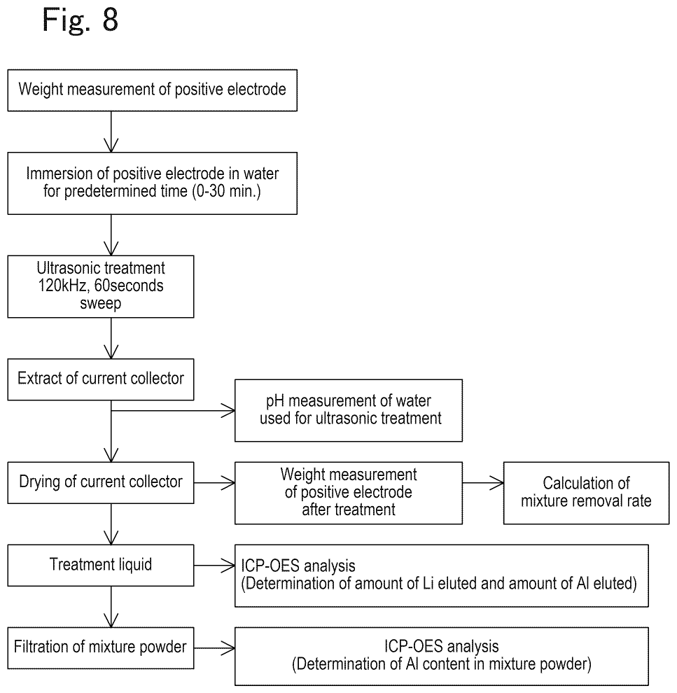

It was found that the likelihood of the mixture layer being separated from the current collector was reduced when the amount of waiting time during which the electrode (in particular, the positive electrode) was immersed in water prior to the separation performed by the above ultrasonic treatment was increased. The reasons for this are considered as follows. When a positive electrode is immersed in water, an alkali metal component (e.g., lithium) elutes from the positive electrode active material. This makes the water alkaline. As a result of the water being made alkaline, a current collector component (e.g., aluminum) elutes into the water and, consequently, the mixture and aluminum form a compound, which inhibits the above separation. It is considered that, accordingly, the mixture may remain on the current collector disadvantageously. Accordingly, a technique for limiting the reduction in the rejection rate of the mixture layer by, in a method for separating a positive electrode current collector and a positive electrode mixture from each other using an ultrasonic treatment, adjusting at least one of the amount of waiting time [min] during which a treatment target electrode that has not been treated with an ultrasonic wave is held in water, the pH [−] of the water used for the ultrasonic treatment, the amount of Li eluted [mg/L] (the concentration of the alkali metal component in the water used for the ultrasonic treatment), and the amount of Al eluted [%] (the amount of current collector dissolved in water per weight of the current collector) was studied. FIG. 8 is a flowchart illustrating an example of the separation method according to the above example.

### Treatment Target Electrode

The above-described positive electrode A was used as a treatment target electrode. The proportion of the mixture included in the positive electrode was 74% by weight.

### Ultrasonic Treatment

An ultrasonic device (GCX-M-3FQ12 produced by Branson, output: 500 W, cleaning tank capacity: 20 L) was used. Water (pure water, pH: 6) was charged into the cleaning tank (outer tank), and 50 ml of an aqueous solution was charged into an inner tank that was a glass container, into which a positive electrode having an area of 40 mm×100 mm was charged. The positive electrode was immersed therein for a predetermined amount of time. Subsequently, an ultrasonic wave was applied using the vibrator disposed below the outer tank. The ultrasonic treatment was performed under the following conditions: frequency: 120 kHz, sweep width: ±1 kHz, sweep rate: 1000 sweep cycles/sec, and treatment time: 60 seconds.

### Analysis

The measurement of the pH of the treated water, the measurement of the weight of the positive electrode, and an ICP-OES analysis were conducted at the timings illustrated in FIG. 8. In the ICP-OES analysis, the Li concentration [mg/L] in the treated water, the Al concentration [mg/L] in the treated water, and the weight proportion [%] of aluminum included in the mixture powder were measured using an inductively coupled plasma optical emission spectroscopy device (ICP-OES, PS3520UVDDII II produced by Hitachi High-Tech Science Corporation). The above Li concentration [mg/L] was considered as the amount of Li eluted. The amount [%] of the current collector (Al) eluted into water per weight of the current collector (Al) was derived from the Al concentration [mg/L] and considered as the amount of Al eluted. Furthermore, the Al content in the mixture was determined as in [Analysis of Proportion of Current Collector Foil Component Included in Mixture] above. The mixture removal rate was derived from the results of weight measurement. The mixture removal rate is the value determined by dividing the reduction rate in the weight of the positive electrode which occurred during the separation step by the weight proportion of the mixture included in the positive electrode, that is, 74%, which is expressed in percentage. In the case where the Al foil is damaged and the weight thereof is reduced, the above weight reduction is also included in the calculation of the mixture removal rate.

### Results and Discussions

Table 3 summarizes the amount [min] of waiting time during which immersion in water was performed, the pH subsequent to the ultrasonic treatment, the amount [mg/L] of Li eluted, the amount [%] of Al eluted, the Al content [%] in the mixture powder, the mixture removal rate [%], and the evaluation of the mixture removal rate, which were determined in each of Test Examples 20 to 28. As for the standard used in the evaluation of the mixture removal rate, an evaluation grade of A was given when the mixture removal rate was 99% or more, an evaluation grade of B was given when the mixture removal rate was 97% or more and less than 99%, an evaluation grade of C was given when the mixture removal rate was 90% or more and less than 97%, an evaluation grade of D was given when the mixture removal rate was 80% or more and less than 90%, and an evaluation grade of F was given when the mixture removal rate was less than 80%. In Table 3, “Immediately afterwards” as for immersion waiting time means that the ultrasonic wave was applied immediately after the positive electrode had been immersed. Test Example 20 is a test example in which the treatment was performed in the same manner as in Test Example 3. In each of Test Examples 20 to 28, damage to the current collector was evaluated as “Damaged” or “No damage” when a hole or a chip was confirmed or not confirmed visually in the foil, respectively. An evaluation of “No damage” was given in all of Test Examples 20 to 28.

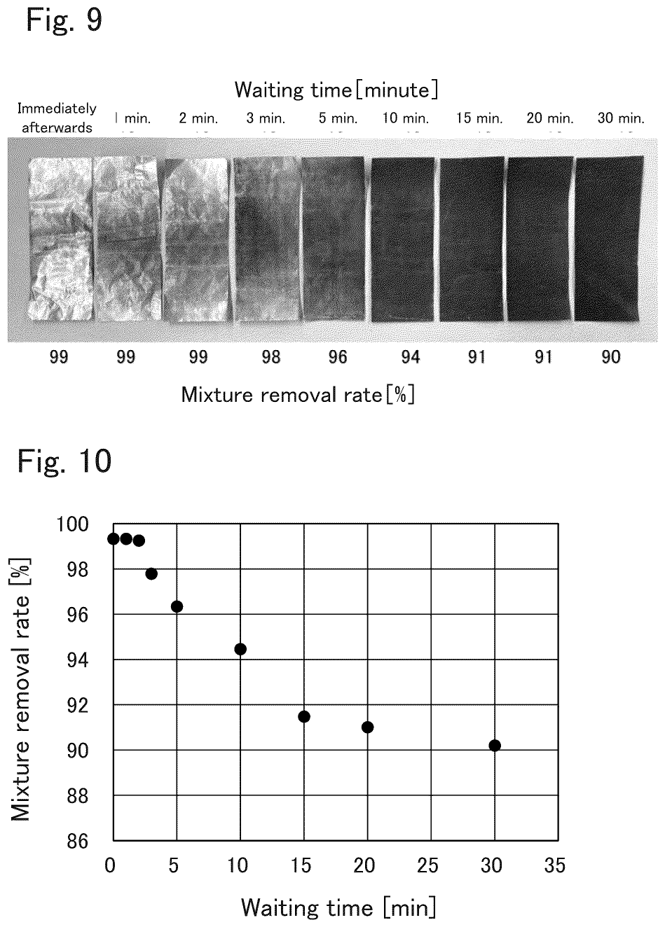

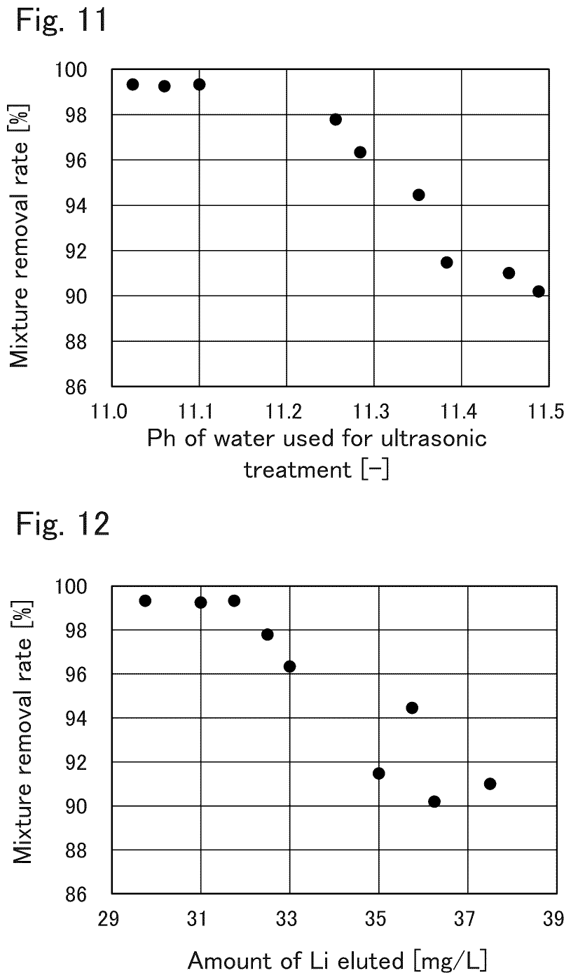

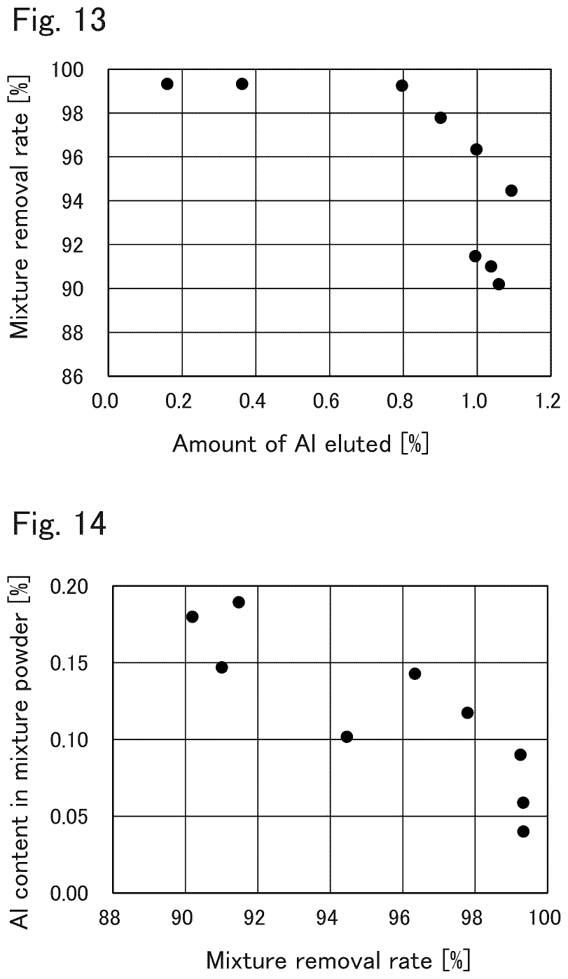

FIG. 9 is a photograph illustrating the appearances of electrodes that had been subjected to the ultrasonic treatment after a lapse of different waiting times. FIG. 10 is a graph illustrating the relationship between the waiting time and the mixture removal rate. FIG. 11 is a graph illustrating the relationship between the pH of the water used for the ultrasonic treatment and the mixture removal rate. FIG. 12 is a graph illustrating the relationship between the amount of Li eluted and the mixture removal rate. FIG. 13 is a graph illustrating the relationship between the amount of Al eluted and the mixture removal rate. FIG. 14 is a graph illustrating the relationship between the mixture removal rate and the Al content in the mixture powder. As described in Table 3 and FIGS. 9 to 14, in all of Test Examples 20 to 28, a high mixture removal rate of 90% or more was achieved. As illustrated in FIG. 10, the shorter the waiting time, the higher the mixture removal rate. When the waiting time was 30 minutes or less, the mixture removal rate was 90% or more. When the waiting time was less than 5 minutes, the mixture removal rate was 97% or more. It is more preferable that the waiting time be less than 3 minutes because, in such a case, the mixture removal rate was 99% or more. As illustrated in FIG. 11, the lower the pH of the water used for the ultrasonic treatment, the higher the mixture removal rate. When the above pH was 11.5 or less, the mixture removal rate was 90% or more. When the above pH was less than 11.4, the mixture removal rate was 96% or more. It is more preferable that the above pH be less than 11.2 because, in such a case, the mixture removal rate was 99% or more. As illustrated in FIG. 12, the lower the amount of Li eluted, the higher the mixture removal rate. When the amount of Li eluted was 37.5 mg/L or less, the mixture removal rate was 90% or more. When the amount of Li eluted was less than 33 mg/L, the mixture removal rate was 97% or more. It is more preferable that the amount of Li eluted be less than 32 mg/L because, in such a case, the mixture removal rate was 99% or more. As illustrated in FIG. 13, the lower the amount of Al eluted, the higher the mixture removal rate. When the amount of Al eluted was 1.1% or less, the mixture removal rate was 90% or more. When the amount of Al eluted was less than 1.0%, the mixture removal rate was 97% or more. It is more preferable that the amount of Al eluted be less than 0.9% because, in such a case, the mixture removal rate was 99% or more. Thus, it was confirmed that the reduction in the rejection rate of the mixture layer can be limited by adjusting at least one of the amount of waiting time, the pH of the water used for the ultrasonic treatment, the amount of Li eluted [mg/L], and the amount of Al eluted [%]. As illustrated in FIG. 14, the higher the mixture removal rate, the lower the Al content in the mixture powder. When the mixture removal rate was 90% or more, the Al content in the mixture powder was 0.18% or less. It is more preferable that the mixture removal rate be 99% or more because, in such a case, the Al content in the mixture powder was less than 0.10%.

TABLE 3

| | | pH of water used | | | Al content | Mixture | Evaluation of |
|---|---|---|---|---|---|---|---|
| | Waiting | for ultrasonic | Amount of | Amount of | in mixture | removal | mixture removal |
| | time | treatment | Li eluted ¹⁾ | Al eluted ²⁾ | powder ³⁾ | rate ⁴⁾ | rate ⁵⁾ |
| | min | — | mg/L | % | % | % | — |
| Test | Immediately | 11.1 | 31.8 | 0.2 | 0.04 | 99 | A |
| Example 20 | afterwards | | | | | | |
| Test | 1 | 11.0 | 29.8 | 0.4 | 0.06 | 99 | A |
| Example 21 | | | | | | | |
| Test | 2 | 11.1 | 31.0 | 0.8 | 0.09 | 99 | A |
| Example 22 | | | | | | | |
| Test | 3 | 11.3 | 32.5 | 0.9 | 0.12 | 98 | B |
| Example 23 | | | | | | | |
| Test | 5 | 11.3 | 33.0 | 1.0 | 0.14 | 96 | C |
| Example 24 | | | | | | | |
| Test | 10 | 11.4 | 35.8 | 1.1 | 0.10 | 94 | C |
| Example 25 | | | | | | | |
| Test | 15 | 11.4 | 35.0 | 1.0 | 0.19 | 91 | C |
| Example 26 | | | | | | | |
| Test | 20 | 11.5 | 37.5 | 1.0 | 0.15 | 91 | C |
| Example 27 | | | | | | | |
| Test | 30 | 11.5 | 36.3 | 1.1 | 0.18 | 90 | C |
| Example 28 | | | | | | | |

¹⁾ The concertation of the alkali metal component (Li)in the water used for the ultrasonic treatment
²⁾ The amount of the current collector (Al) dissolved in the water per weight of the current collector (Al)
³⁾ The proportion of the current collector component (Al) included in the separated electrode mixture
⁴⁾ The value determined by dividing the reduction rate in the weight of the electrode by the weight proportion (74%) of the mixture included in the electrode, which is expressed in percentage
⁵⁾ A: 99% or more, B: 97% or more, C: 90% or more and less than 97%, D: 80% or more and less than 90%, F: less than 80%

The present application claims priority to Japanese Patent Application No. 2022-121627 filed Jul. 29, 2022, the entire contents of which are incorporated herein by reference.

### Industrial Applicability

The present disclosure can be used in the battery industry.

### REFERENCE SIGNS LIST

10 separation device, 15 controller, 20 ultrasonic device, 22 treatment container, 24 inner tank, 25 stage, 26 outer tank, 28 vibrator, 30 oscillator, 32 treatment liquid, 33 mixture-containing treatment liquid, 36 ultrasound propagating medium, 50 treatment target electrode, 52 current collector, 54 electrode mixture, 60 separation unit, 62 pipe, 62a valve, 70 import unit, 72 conveyor, 80 current collector export unit, 82 robot arm, 84 conveyor, 86 rinsing device, 88 drying device, 90 mixture export unit, 92 pipe, 92a valve, 94 filtering device, 96 conveyor, 98 drying device

1. A separation method comprising a separation step in which a treatment target electrode that includes a current collector and an electrode mixture disposed on the current collector is treated with an ultrasonic wave in water while a frequency of the ultrasonic wave is swept, in order to separate the current collector and the electrode mixture from each other.

2. The separation method according to claim 1,
wherein, in the separation step, the treatment target electrode including the electrode mixture including at least one selected from an organic binder and an aqueous binder is treated with the ultrasonic wave.

3. The separation method according to claim 1, wherein, in the separation step, the sweeping is performed with a center being a fundamental frequency of 80 kHz or more and 200 kHz or less.

4. The separation method according to claim 1, wherein, in the separation step, the sweeping is performed at a sweep width of within ±3 kHz with a center being a fundamental frequency.

5. The separation method according to claim 1, wherein, in the separation step, the sweeping is performed at a sweep rate of 500 sweep cycles/sec or more.

6. The separation method according to claim 1, wherein, in the separation step, the ultrasonic treatment is performed for 10 minutes or less.

7. The separation method according to claim 1, wherein, in the separation step, when an area of a contact portion between the current collector and the electrode mixture is defined as A [cm²] and an output of the ultrasonic wave is defined as B [W], the ultrasonic treatment is performed such that an output density represented by B/A is 10 W/cm² or less.

8. The separation method according to claim 1, wherein a proportion of the current collector component included in the electrode mixture separated in the separation step is less than 0.1% and a proportion of the electrode mixture component included in the current collector separated in the separation step is less than 0.2%.

9. The separation method according to claim 1, wherein, in the separation step, the ultrasonic treatment is performed in an unheated environment.

10. The separation method according to claim 1, wherein the ultrasonic treatment is performed in a batch or continuous mode.

11. The separation method according to claim 1, the method further comprising:
an extraction step in which an electrode is extracted from an energy storage device,
wherein, in the separation step, the electrode extracted in the extraction step is used as the treatment target electrode and treated with the ultrasonic wave without being shredded.

12. The separation method according to claim 1, the method further comprising at least one selected from a current collector treatment step in which the current collector separated in the separation step is rinsed and subsequently dried and a mixture treatment step in which the electrode mixture is separated from mixture-containing water and subsequently dried, the mixture-containing water including the electrode mixture separated in the separation step.

13. The separation method according to claim 1, wherein the separation step is conducted such that one or more selected from (1) to (6) below are satisfied:
(1) in the separation step, a pH of the water used for the ultrasonic treatment is 11. 5 or less,
(2) in the separation step, a concentration of an alkali metal component in the water used for the ultrasonic treatment is 37.5 mg/L or less,
(3) in the separation step, an amount of the current collector dissolved in the water per weight of the current collector is 1.1% or less,
(4) in the separation step, an amount of waiting time during which the treatment target electrode that has not been subjected to the ultrasonic treatment is held in the water is 30 minutes or less,
(5) in the separation step, a proportion of the current collector component in the separated electrode mixture is 0.18% by weight or less, and
(6) in the separation step, a rejection rate at which the electrode mixture is removed from the current collector is 90% or more.

14. A separation device comprising:
a separation unit that treats a treatment target electrode including a current collector and an electrode mixture disposed on the current collector with an ultrasonic wave in water to separate the current collector and the electrode mixture from each other; and
a controller that controls the separation unit such that the ultrasonic treatment is performed while a frequency of the ultrasonic wave is swept.
